(19) United States
(12) Patent Application Publication
(10) Pub. No.: US 2022/0298833 A1
(43) Pub. Date: Sep. 22, 2022

(54) External opening control with multi-articulated pallet

(71) Applicant: AKWEL VIGO SPAIN SL, Vigo Pontevedra (ES)

(72) Inventors: Agustin REGUEIRO BLANCO, A Coruña (ES); Julio GARCIA RODRIGUEZ, Pontevedra (ES)

(73) Assignee: AKWEL VIGO SPAIN SL, Vigo Pontevedra (ES)

(21) Appl. No.: 17/696,185

(22) Filed: Mar. 16, 2022

(30) Foreign Application Priority Data
Mar. 16, 2021 (FR) 2102599

(51) Int. Cl. E05B 79/06; E05B 85/18; B60J 5/04

(52) U.S. Cl. CPC E05B 79/06; E05B 85/18; B60J 5/0413

(57) ABSTRACT

A control configured for being integrated and concealed in a window pillar of the door, the control including a manual maneuvering member of the gripping pallet type, an interface base arranged on the pillar and on which the pallet is mounted articulated between an idle position integrated in the pillar so as to be flush and a deployed working position projecting from the pillar. It includes a mechanism for articulating the pallet on the base configured for allowing a movement of the pallet on a path in elevation and pivoting with respect to the base. Furthermore, the pallet includes a trim on the pillar, secured to the pallet, conformed for at least partially cladding the periphery of the pillar and for covering the interface base in the idle position.

The present invention relates to an external opening control for a door of an automobile. More particularly, this invention relates to an external opening control of a side door of an automobile, which may indifferently be a front door or a rear door, a control that is integrated and concealed in a pillar, for example a pillar of the bodywork of the vehicle delimiting a side window or a rear pillar of a rear-quarter panel, adjacent to the door in question.

The side doors of automobiles are generally equipped with an opening control a visible part of which is a handle, usually referred to as a gripping pallet, having a general form comparable to that of a refrigerator door handle. Such handles in general form significant protrusions on the sides of the bodywork of the vehicle or, even if they are more or less embedded in the door panel, they remain very visible.

A current trend, in the design of automobiles, is to make the controls discreet, by attempting to hide them. In particular, with regard to the external opening controls of doors, it has already been proposed to conceal these controls by integrating them in the frame of the door, by providing a handle of the pallet type flush with a pillar located at the rear of the window of the door in question. One example of an external opening control of a door of this type can be found in the French patent application FR 3034713 A1.

However, such an external opening control cannot be completely concealed on the pillar, since the pallet necessarily includes a large central cutout provide for introducing the hand and for manipulating this pallet. Thus there remains, with regard to the installation of the opening control on the pillar, lines delimiting the various members making up the opening control that impair the overall perception of the whole by an observer.

The aim of the invention is in particular to provide an external opening control remedying these aforementioned drawbacks of the prior art.

For this purpose, the object of the invention is in particular an external opening control for a door of an automobile, in particular a rear side door of the vehicle, configured for being integrated and concealed in a window pillar of the door, the control comprising a manual maneuvering member of the gripping pallet type, an interface base arranged on the pillar and on which the pallet is mounted articulated between an idle position integrated in the pillar so as to be flush and a deployed working position projecting from the pillar, characterized it that it comprises a mechanism for articulating the pallet on the base configured for allowing a movement of the pallet on a path in elevation and in pivoting with respect to the base, and in that the pallet comprises a trim on the pillar, secured to the pallet, conformed for at least partially cladding the periphery of the pillar and for covering the interface base in the idle position.

The external opening control does not at rest have any protrusion or any interruption with respect to the profile of the bodywork at the pillar. The trim formed by the pallet is perfectly integrated on the pillar, for example from one edge to the other of the pillar, which provides an aesthetic finish for the vehicle.

The pallet is gripped simply for example by introducing the hand under the pallet in order to grip it and to be able to move the pallet on a path in elevation and in inclination. The gripping of the pallet is also optimized from an ergonomic point of view since it makes it possible to limit the amplitude of twisting of the wrist of the user by virtue of its path component in elevation. Finally, by means of the articulation mechanism allowing a movement of the pallet according to a path component in elevation in addition to a circular path component, the general form of the pallet may have a complex geometry making it possible to adapt to the profile of the pillar on which the opening control is intended to be integrated. The general form of the pallet is thus no longer limited to constraints of angular movement inside its reception base.

As is known per se, movement of the pallet will cause the actuation of an internal mechanism of the opening control, for example the actuation of a transmission lever which, itself, exerts a traction on a cable opening the lock of the door concerned.

An opening control according to the invention may furthermore include one of the following features.

In the preferred embodiment, the trim is configured for delimiting at least a portion of the pillar from one edge of the pillar to the other in a direction substantially transverse to this pillar.

In the preferred embodiment, the trim is conformed to perfectly follow the external shape of the pillar.

In the preferred embodiment, the pallet has a decorative external face forming the trim and a masked opposite internal face cooperating through the articulation mechanism with the interface base.

In the preferred embodiment, the pallet, having the general form of a plate delimiting a visible external face forming the trim and an opposite internal face, is provided with a hollow bulging part provided projecting on the internal face delimiting a concave housing adapted for receiving the hand of a user wishing to grip the pallet.

In the preferred embodiment, the base comprises an internal face provided with a part in the form of a hollow housing in which the bulging part of the pallet can be embedded completely by complementarity of shape.

In the preferred embodiment, said hollow bulging part of the pallet being provided with two lugs each provided with a through orifice for an articulation spindle of the articulation mechanism to pass, each lug is configured for passing through the housing of the base through a recess provided in the housing.

In the preferred embodiment, the pallet comprises a decorative external face covered with a trim cladding of the mat or glossy adhesive type.

In the preferred embodiment, the base comprises a window-guide piece and the trim is configured for receiving this piece.

In the preferred embodiment, the articulation mechanism comprises first and second levers articulated on the pallet and the base in order to define with the pallet and the base a connection of the articulated quadrilateral type.

In the preferred embodiment, each lever comprises proximal and distal portions connected rotatably respectively to the pallet and to the base and the distal portion of at least one of the levers is provided with a fork with two arms between which the proximal portion of the other one of the levers extends in a retracted configuration of the articulation mechanism.

In the preferred embodiment, the control comprises a transmission lever for actuating a lock of the door mounted so as to pivot about a spindle secured to the base, the articulation mechanism cooperating with the transmission lever so as to cause the pivoting of the transmission lever when the member moves.

In the preferred embodiment, the trim comprises a lateral edge designed to be mounted near a glazed panel of the door having a non-rectilinear contour.

The invention also relates to an automobile door comprising an external opening control, characterized in that the opening control is an opening control according to the invention integrated in or concealed in a pillar of a window panel of the door.

Finally, the invention relates to an automobile comprising a door according to the invention, wherein the opening control is accessible for gripping through a cavity provided in a wall of the vehicle that is adjacent to the pillar of the door, such as a wall of a rear-quarter panel.

Other features and advantages of the invention will emerge in the light of the following description, made with reference to the accompany drawings, wherein:

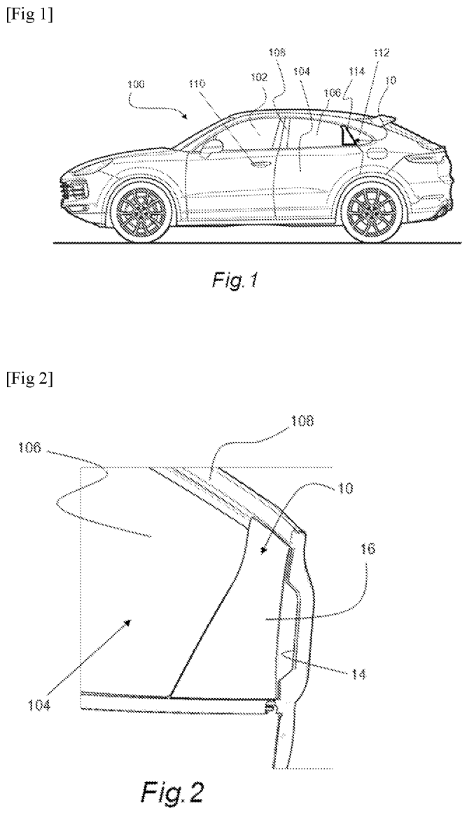

FIG. 1 shows a perspective view of a motor vehicle comprises external opening control according to the invention;

FIG. 2 shows a partial view to an enlarged scale illustrating the external opening control of FIG. 1;

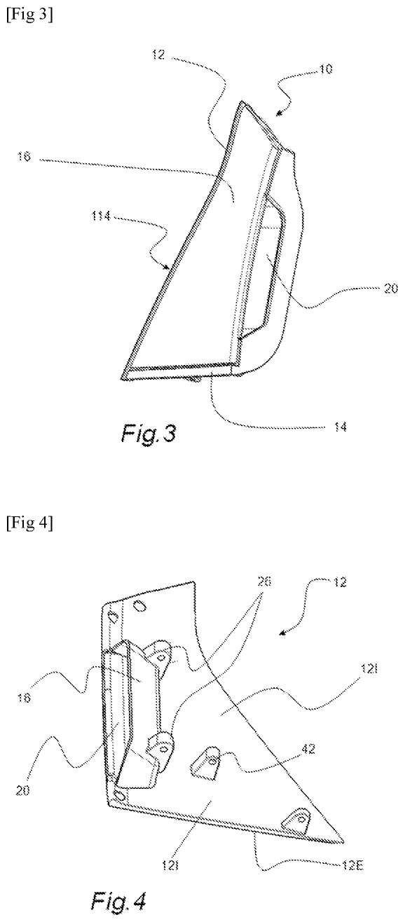

FIG. 3 shows a front-perspective view of the external opening control of a rear door of FIGS. 1 and 2;

FIG. 4 shows a perspective view of an internal face of a gripping pallet of the opening control of FIG. 3;

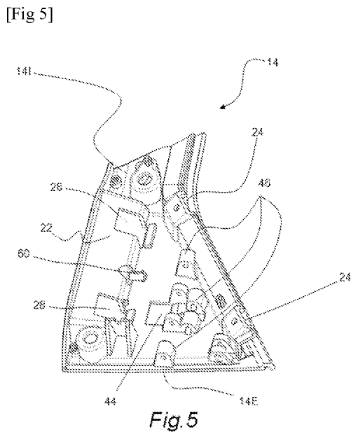

FIG. 5 shows a perspective view of an internal face of the interface base of the opening control of FIG. 3;

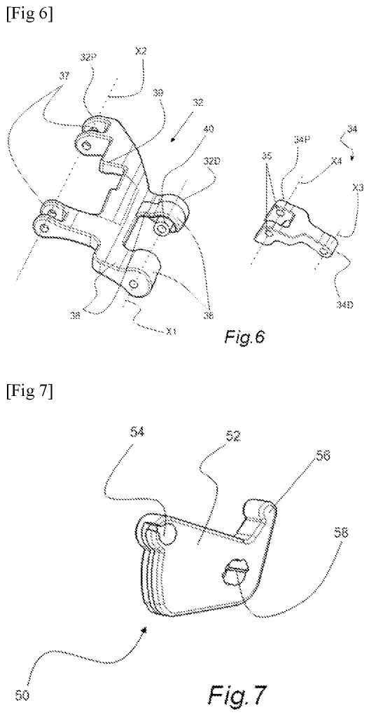

FIG. 6 shows a perspective view of the articulation levers of an articulation mechanism of the opening control shown on FIG. 3;

FIG. 7 shows a perspective to an enlarged scale of a mechanical-actuation transmission lever of a lock of the opening control of the opening control shown on FIG. 3;

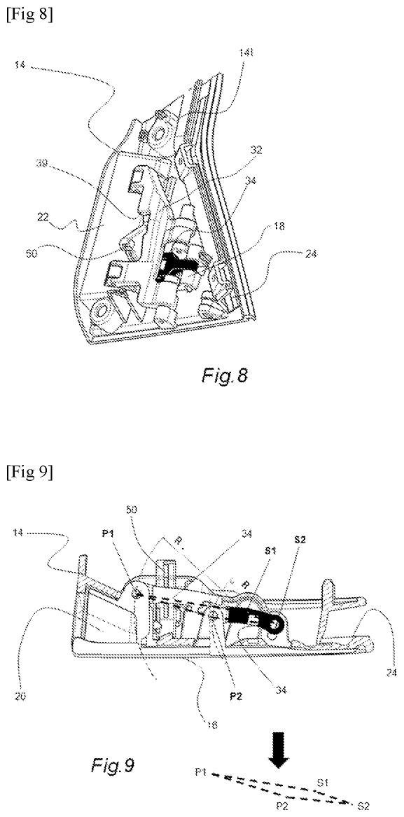

FIG. 8 shows a perspective view from below of the opening control shown on FIG. 3 in an idle position;

FIG. 9 shows a view in cross-section of the control shown on FIG. 8;

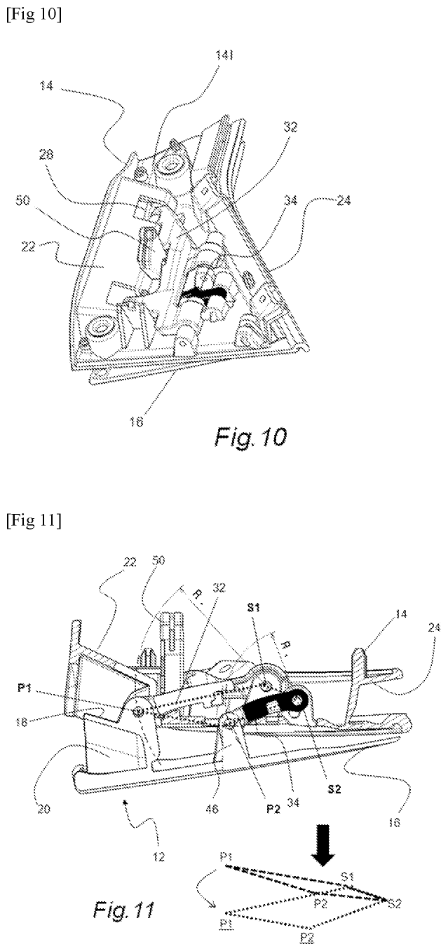

FIG. 10 shows a perspective view from below of the opening control shown on FIG. 3 in a deployed position;

FIG. 11 shows a view in cross-section of the control shown on FIG. 10.

FIG. 1 shows an automobile designated by the general reference 100. This vehicle 100 is a four-door vehicle, with two front side doors 102 and two rear side doors 104.

These side doors 102 and 104 are all equipped with external opening controls, namely an opening control 110 for each front door 102 and an opening control 10 according to the invention for each rear door 104.

Each side door 102 or 104 comprises a door shell including conventionally a carrier structure that is an integral part of the body work of the vehicle, lined by an external door wall formed by an external metal sheet of the vehicle and referred to as a door panel.

The carrier structure of the door also comprises, in line with the door panels, a frame 108 that defines the upper contour of the door and inside which a movable or fixed glazed panel 106 generally extends. In the example illustrated, the window frame 108 is intended to frame and hold the window and comprises two lateral pillars extending vertically and able to be connected or not at the top ends by a horizontal cross-member.

On each side of the vehicle, in the example illustrated, the opening control 110 of the front door 102 is mounted on the external bodywork of the front door 102 and is in the form of a handle mounted so as to project from the door panel opposite a hollow formed in the metal sheet of this panel. The handle is in the form of a slender body externally convex so as to form, between the body and metal sheet, a passage opening for the fingers of a hand in the hollow to allow traction on the panel so as to open the door.

In accordance with the invention, the opening control 10 of the rear door 104 is located in proximity to a rear vertical pillar 114, at a vertical pillar of the frame of the window of this rear door 104.

In the example illustrated, the rear pillar 114 separates a window of the rear door 104 from a solid rear-quarter panel 112 and, in this case, the opening control 10 is located in proximity to this rear-quarter panel 112. Naturally, in a variant that is not illustrated, the vehicle may include a glazed rear-quarter panel (known according to English terminology by the expression “quarter window”).

FIG. 2 shows, more particularly, the external opening control 10 associated with the rear door 104 in accordance with one embodiment of the invention. This control 10 comprises a manual maneuvering member 12 that is externally in the form of a gripping pallet 12.

Furthermore, with reference to FIG. 2 or FIG. 3, the control 10 comprises an interface base 12 on which the maneuvering member 12 is mounted articulated so as to be able to move with respect to the base 14 between an idle position integrated flush with the rear pillar 114 and an operating position projecting with respect to the rear pillar 114.

For this purpose, the control 10 also comprises a mechanism 30 for articulating the pallet 12 on the base 14 configured for allowing a movement of the pallet 12 on a path in elevation and in inclination with respect to the base 14.

In accordance with the invention, the member 12 comprises a trim 16 of the pillar 114 conformed for at least partially cladding the periphery of the pillar 114 and for covering the interface base 14 in the idle position.

Preferably, the trim 16 is configured for delimiting at least a portion of the pillar 114 from one edge of the pillar 114 to the other in a direction substantially transverse to this pillar 114. With such a configuration, the trim 16 has no inaesthetic interruption from one edge of the pillar 114 to the other.

In the example illustrated and in a preferred embodiment of the invention, the trim 16 is conformed to perfectly match the external shape of the pillar 114. This conformation of the trim 16 guarantees an optimal aesthetic finish of the opening control 10.

Preferably, the trim 16 has a roughly elongate shape intended to extend longitudinally vertically along one side of the frame 108 of the glazed panel 106. The trim 16 extends, in this example, at one of its lateral borders (to the left in FIG. 2) on the window frame 106 and at the other of its lateral borders (to the right in FIG. 2) at the peripheral edge of the rear door 104.

As can be seen on FIGS. 1 to 4, this pallet 12 consists for example of a substantially flat face made from plastics material. This pallet 12 has for example a decorative external face 12E forming the trim 16 and a masked internal face 12I mounted articulated on the base 14.

The pallet 12 preferably comprises, on its decorative external face 12E, a cladding of the matt or glossy adhesive type, generally of a dark color such as a black color. Furthermore, this cladding may preferably be selected identical to the cladding of the solid rear-quarter panel 112.

In the example described, the pallet 12 is in the general form of a plate delimiting the visible external face 12A forming the trim 16.

Furthermore, preferably, the masked internal face 12B of the pallet 12 is provided with a hollow bulging part 18 provided projecting on the internal face 12B delimiting a concave housing 20 adapted for receiving the hand of a user wishing to grip the pallet 12. In the example illustrated, the concave housing 20 is open on the same side as a lateral external edge of the door 104.

FIG. 5 shows the interface base 14 forming a support for the pallet 12 on which the pallet 12 is mounted articulated as will be described below.

In the example illustrated, the base 14 comprises an external face 14E and an internal face 14I turned in the direction of the door 104 and attached directly for example to a bodywork pillar of the door 104 by various attachment means provided.

The base 14 preferably comprises on its internal face 14I a part in the form of a hollow housing 22 wherein the bulging part 18 of the pallet 12 can fit completely by complementarity of shape.

The base 14 preferably comprises, on one of its lateral edges, also a window-guide part 24 in the general form of a U for guiding the window 106 in its vertical sliding.

In the idle position, the pallet 12 is located flush with the bodywork, more particularly with the frame 108 of the window 106, as shown by FIG. 2 or FIG. 3.

In accordance with the invention, the opening control 10 comprises a mechanism 30 for articulating the pallet 12 on the base 14 configured for allowing a movement of the pallet 12 on a path in elevation and in inclination with respect to the base 14.

This articulation configuration makes it possible to be free from the constraints related to the geometric shape of the pallet 12 by virtue of the degree of freedom of movement in elevation of the pallet 12 with respect to an external surface of the door 104.

For example, the trim 16 comprises a lateral edge designed to be mounted near a glazed panel 106 of the door 104 that has a non-rectilinear contour. More generally, the contour of the trim may represent a complex geometric figure that is not necessarily triangular or rectangular because of its movement in elevation. This has an important advantage of perfectly integrating the opening control in the rear pillar of the door whatever the shape of the rear pillar 114.

The articulation mechanism 30 comprises first 32 and second 34 levers articulated on the pallet 12 and the base 14 in order to define conjointly with the pallet 12 and the base 14 a connection of the deformable articulated quadrilateral type.

In this example, the first lever 32 is connected rotatably to the base 14 on a first distal pivot axis X1 and to the pallet 12 on a first proximal pivot axis X2. Likewise, the second lever 34 is connected rotatably to the base 14 on a second distal pivot axis X3 and to the pallet 12 on a second proximal pivot axis X4. These pivot axes X1 to X4 preferably extend in a direction vertical to the automobile and substantially parallel with respect to each other. The pallet 12 is thus articulated on the base 14 through a deformable structure defining a quadrilateral as will be explained below.

A midplane substantially orthogonal to the pivot axes X1 to X4 such as the cutting plane in FIG. 9 or 11 is considered. In this plane, the quadrilateral articulated with fictional points (obtained by orthogonal projection of the real articulation points in the midplane) P1 and P2 of articulation of the levers 32 and 34 on the pallet 12 and S1 and S2 of articulation on the base 14 can be defined. In this quadrilateral, the sides are formed by the pivoting radii of the levers 32 and 34 and the segment separating the articulation points S1 and S2 on the base 14 on the one hand and the segment separating the articulation points P1 and P2 on the pallet 12 on the other hand.

During the movement of the pallet 12, it can be seen in particular on FIG. 11 that the initial quadrilateral (in broken lines) deforms to form the final quadrilateral (in dotted lines). The pallet 12 (segment P1-P2) pivots and rises with respect to the interface base 14 (segment S1-S2).

Preferably, each lever 32 (and respectively 34) comprises proximal 32P (and respectively 34P) and distal 32D (and respectively 34D) portions connected rotatably respectively to the pallet 12 and to the base 14.

In this example, the first lever 32 is a lever with a larger radius of movement than that of the second lever 34. As is clear from FIG. 9 or 11, the levers have longitudinal profiles, between their two articulations, that are roughly rectilinear but may however be slightly curved.

Moreover, preferably, the distal portion 32D of the first lever 32 is provided with a fork with two arms 36A, 36B between which the proximal portion 34p of the second lever 34 extends in a retracted configuration of the articulation mechanism 30.

Thus the two levers 32 and 34 are arranged by being engaged in each other in the retracted configuration corresponding to the idle position of the maneuvering member 12.

On FIG. 8, it can be seen that the distal portion 32D of the first lever 32 terminates in the form of a fork comprising the two arms 36 distant from each other and each terminating in a guide bearing respectively 38A and 38B rotating about an associated journal 40, secured to the base 14.

The two journals 40 extend at a distance from each other along the first distal rotation axis X1 in order to form two distinct regions of distal articulation between which the proximal portion 34P of the second lever 34 can at least partially extend in its retracted configuration.

Furthermore, in the example illustrated, the proximal portion 32P of the lever 32 also terminates in the form of a fork with two arms 37 distant from each other and having at the end two parallel pierced cheeks for receiving the rotation axis X1. In the example illustrated, the hollow bulging part 20 of the pallet 12 is provided with two lugs 26 each provided with a transverse orifice aligned for the passage of an articulation axis X2 of the articulation mechanism 30. For example, each lug 26 is configured for passing through the housing of the base 14 through a corresponding recess 28 provided in the housing 22 of the base 14. These lugs 26 thus form supports for articulation and mounting of the rotation axis X2 of the proximal part 32P of the lever 32.

Moreover, in an example, the pallet 12 also comprises an articulation support in the form of a relief 42 projecting on the internal face 12I of the pallet 12 and pierced so as to support respectively the articulation axis X4 of the proximal end part 34P of the lever 34. Furthermore, in the example illustrated on FIG. 5, the base 14 comprises a recess 44 through which the articulation support 42 is engaged. The second lever 34 has for example a proximal part 34P in the form of a fork with two arms 35.

In a similar fashion, the base 14 comprises articulation supports 46 for supporting respectively the distal end parts 34P and 34D of the two levers 32 and 34. Naturally, this mounting configuration is a detail of embodiment of the invention that is no way limitative.

The control 10 furthermore comprises in a conventional fashion a transmission mechanism 30 for transmitting the movement of the pallet 12 to a cable intended to control a lock (not shown) of the door.

The mechanism 30 comprises a transmission lever 50 that is connected for example to a remote-actuation cable directed towards the lock (not shown) of the door in question. For example, the transmission lever 50 is mounted so as to pivot about a spindle secured to the base 14 concretized by a journal 60, for example extending perpendicular to the articulation axes X1 to X4 of the mechanism 30.

Moreover, according to a preferred embodiment of the invention, the articulation mechanism 30 is arranged to cooperate with the transmission lever 50 so as to cause the pivoting of the transmission lever 50 when the maneuvering member 12 moves.

The transmission lever 50 comprises for example a body 52 with a roughly flat and elongate shape. The body 52 also has, in its elongate direction, an end head 54 provided with a housing for receiving one end of a mechanical traction cable of the lock (not shown).

The body 52 terminates in an end foot in the form of a curved appendage 56. For example, the first lever 32 then has a stop relief 39 that encounters the foot 56 of the transmission lever 50 during its opening path towards the deployed position of the pallet 12 to drive the pivoting of the transmission lever 50 and the traction on the lock cable.

Furthermore, the body 52 has a through orifice 58 for its pivoting articulation about the journal 60. In the example illustrated, the journal 60 is mounted transversely on a boss of the base 14 formed by the wall of the hollow housing 22. It can be seen in particular that the transmission lever 50 extends adjacent to the external wall of the hollow housing 22 in its longitudinal direction from between the two recesses 28.

In the example illustrated, the opening control 10 is accessible for gripping through a cavity formed in a wall of the vehicle 100 that is adjacent to the pillar 114 of the door 104. In the example illustrated, the cavity is formed in the rear-quarter panel 112.

The reverse return path of the pallet to the flush position after the door is opened is done by means of elastic means of the spring type that will not be described further.

The main aspects of the operation of an opening control according to the invention will now be described with reference to FIGS. 9, 10 and 11.

Initially, the pallet 12 is positioned in its idle flush configuration. The trim 16 then perfectly matches the rear vertical pillar 114 so that the opening control 10 is completely concealed in the pillar 114.

Next, to initiate the pivoting of the pallet 12, the user engages the fingers of one of his hands inside the hollow 20 formed in the opening control 10 and thus manages to grip this pallet 12, and then to engage the movement of the pallet 12 into its deployed position.

This movement leads to the lifting and pivoting of the pallet 12 to a position of maximum elevation and pivoting towards the outside (FIG. 11). At the end of movement of the pallet 12, the relief of the first lever 32 acts on the appendage 56 of the transmission lever 50, which causes the traction on the actuation cable, thus opening the door lock.

When the pallet 12 is released, it returns to the initial flush position, under the effect of the various return means provided, which will not be detailed further.

The invention is not limited to the embodiments previously described. Other embodiments within the capability of a person skilled in the art can also be envisaged without departing from the scope of the invention defined by the following claims.

1. An external opening control for a door of an automobile configured for being integrated and concealed in a window pillar of the door, the control comprising a manual maneuvering member of the gripping pallet type, an interface base arranged on the pillar and on which the pallet is mounted articulated between an idle position integrated in the pillar so as to be flush and a deployed working position projecting from the pillar, wherein comprises a mechanism for articulating the pallet on the base configured for allowing a movement of the pallet on a path in elevation and in pivoting with respect to the base, and in that the pallet comprises a trim on the pillar, secured to the pallet, conformed for at least partially cladding the periphery of the pillar and for covering the interface base in the idle position.

2. The opening control according to claim 1, wherein the trim is configured for delimiting at least a portion of the pillar from one edge of the pillar to the other in a direction substantially transverse to this pillar.

3. The opening control according to claim 1, wherein the trim is conformed to perfectly follow the external shape of the pillar.

4. The opening control according to claim 1, wherein the pallet has a decorative external face forming the trim and a masked opposite internal face cooperating through the articulation mechanism with the interface base.

5. The opening control according to claim 1, wherein the pallet, having the general form of a plate delimiting a visible external face forming the trim and an opposite internal face, is provided with a hollow bulging part provided projecting on the internal face delimiting a concave housing adapted for receiving the hand of a user wishing to grip the pallet.

6. The opening control according to claim 1, wherein the base comprises an internal face provided with a part in the form of a hollow housing in which the bulging part of the pallet can be embedded completely by complementarity of shape.

7. The opening control according to claim 1, wherein the hollow bulging part of the pallet being provided with two lugs each provided with a through orifice for an articulation spindle of the articulation mechanism to pass, each lug is configured for passing through the housing of the base through a recess provided in the housing.

8. The opening control according to claim 1, wherein the pallet comprises a decorative external face covered with a trim cladding of the mat or glossy adhesive type.

9. The opening control according to claim 1, wherein the base comprises a window-guide piece and the trim is configured for receiving this piece.

10. The opening control according to claim 1, wherein the articulation mechanism comprises first and second levers articulated on the pallet and the base in order to define with the pallet and the base a connection of the articulated quadrilateral type.

11. The opening control according to claim 1, wherein each lever comprises proximal and distal portions connected rotatably respectively to the pallet and to the base and the distal portion of at least one of the levers is provided with a fork with two arms between which the proximal portion of the other one of the levers extends in a retracted configuration of the articulation mechanism.

12. The opening control according to claim 1, wherein the control comprises a transmission lever for actuating a lock of the door mounted so as to pivot about a spindle secured to the base, the articulation mechanism cooperating with the transmission lever so as to cause the pivoting of the transmission lever when the member moves.

13. The opening control according to claim 1, wherein the trim comprises a lateral edge designed to be mounted near a glazed panel of the door having a non-rectilinear contour.

14. The automobile door comprising an external opening control, wherein the opening control is an opening control according to claim 1 integrated in or concealed in a pillar of a window panel of the door.

15. The automobile comprising a door according to claim 14, wherein the opening control is accessible for gripping through a cavity provided in a wall of the vehicle that is adjacent to the pillar of the door.
